(19) United States
(12) Patent Application Publication
(10) Pub. No.: US 2012/0097810 A1
(43) Pub. Date: Apr. 26, 2012

(54) Stand for a Two Wheeled Device and Method of Using Same

(76) Inventor: Patrick A. Burnett, Crete, IL (US)

(21) Appl. No.: 12/909,528

(22) Filed: Oct. 21, 2010

(51) Int. Cl. F16M 11/04

(52) U.S. Cl. 248/176.1

(57) ABSTRACT

A stand to engage at least one wheel or tire of a device is provided. The stand may include a base having a plurality of legs and a tower extending upward therefrom. The stand further may include a holder having a tire plate coupled to the tower, wherein the tire plate is configured to engage the device, a pair of vise portions coupled to the tire plate to facilitate retaining the device in a stable position, a vise support extending from the tire plate, and a fastening mechanism coupled to the vise support that facilitates moving the holder between an open position and an engaged position.

### BACKGROUND

1. Field of the Invention

The present invention is directed to a novel stand for a two wheeled device and method of using the same.

2. Description of the Related Art

Most motorcycles and two-wheeled devices require routine repair or other maintenance. A user many times needs to access the underside of the device to complete a repair; however, to access the underside of the bike, the kickstand, along with the instability of the device, among other things, can make it difficult to work on the device. Some motorcycle stands have tried to address these issues, but many of these stands are difficult to use with less than two people.

Additionally, some motorcycle stands are unitary structures, wherein both the front and rear wheels of a two-wheeled device are held by the same structure. Such stands typically are bulky and difficult to store and/or transport because of its size.

What is needed is a reasonably priced portable, storable and sturdy motorcycle stand that enables a user to work on the entire underside of the motorcycle when the stand is in use.

### BRIEF SUMMARY OF THE INVENTION

In one aspect, a stand to engage at least one wheel or tire of a device is provided. The stand may include a base having a plurality of legs and a tower extending upward therefrom and a holder. The holder may include a tire plate coupled to the tower, wherein the tire plate is configured to engage the device, a pair of vise portions coupled to the tire plate to facilitate retaining the device in a stable position, a vise support extending from the tire plate, and a fastening mechanism coupled to the vise support that facilitates moving the holder between an open position and an engaged position.

In another aspect, a system is provided. The system may include at least one stand to engage at least one wheel or tire of a device. The stand may include a base having a plurality of legs and a tower extending upward therefrom and a holder. The holder may include a tire plate coupled to the tower, wherein the tire plate is configured to engage the device, a pair of vise portions coupled to the tire plate to facilitate retaining the device in a stable position, a vise support extending from the tire plate, and a fastening mechanism coupled to the vise support that facilitates moving the holder between an open position and an engaged position. The system may further include at least one jack extension to couple to a jack. The jack extension may include a first end and an opposing second end with at least one cross-bar extending therebetween, wherein the jack extension is configured raise the height of the device between a first position and a second higher position.

A method of using a stand is disclosed. The method may include lifting a two-wheeled device off of the ground to a predetermined first height, placing a first stand underneath a first wheel of the device such that a first vise plate engages the first wheel, placing a second stand underneath a second wheel of the device such that a second vise plate engages the second wheel, tightening a first pair of vise plates proximate the first wheel with a first vise fastening mechanism to stabilize the first wheel, tightening a second pair of vise plates proximate the second wheel with a second fastening mechanism to stabilize the second wheel, and raising the two-wheeled device to a predetermined second height, wherein the second predetermined height is greater than the first predetermined height.

### BRIEF DESCRIPTION OF THE DRAWINGS

FIG. 1 is a perspective view of a system, wherein the system may have at least one stand and an extension jack.

FIG. 1A is a perspective view of a stand of the system shown in FIG. 1, for example a stand for the front wheel of a two-wheeled device.

FIG. 1B is a perspective view of a stand of the system shown in FIG. 1, for example a stand for the rear wheel of a two-wheeled device.

FIG. 2 is an exploded view of the stand of FIG. 1A, wherein the stand may have a base and a holder.

FIG. 2A is another embodiment of a base.

FIG. 3 is left side view of FIG. 1A.

FIG. 3A is right side view of FIG. 1A.

FIG. 4 is a right side view of another embodiment of a base.

FIG. 4A is a left side view of the base of FIG. 4.

FIG. 5 is a front view of FIG. 1A.

FIG. 6 is a rear view of FIG. 1A.

FIG. 7 is a top view of FIG. 1A.

FIG. 8 is a bottom view of FIG. 1A.

FIG. 9 is a perspective view of a jack extension shown in FIG. 1.

FIG. 10 is an exploded view of the jack extension of FIG. 16.

FIG. 11 is a left side view of the jack extension, the right side being a mirror image thereof.

FIG. 12 is a front view of the jack extension, the rear view being a mirror image thereof.

FIG. 13 is a top view of the jack extension.

FIG. 14 is a bottom view of the jack extension.

### DETAILED DESCRIPTION OF THE INVENTION

Broadly, an embodiment of the present invention generally provides a stand 10 for a two-wheeled device 8, such as a motorcycle or a bicycle. Stand 10 may hold a device 8 of any size and weight. Stand 10 provides stability such that device 8 may be held off the ground to enable a user to safely repair or access the underside of the two-wheeled device 8. One advantage of stand 10 is that it can be transported, easily stored and can easily be used by one person.

Additionally, the present invention may include an extension or extension jack 400 that may be used with a standard commercially available jack or lift 12. Extension 400 may be configured to be used in connection with stand 10 and may raise device 8 a distance above the ground. Extension 400 may facilitate raising device 8 a distance above the ground that is greater than that of a standard commercially available jack. Additionally, extension 400 may be removed from the underside of device 8, such that extension 400 does not obstruct or inhibit access to any portion of device 8.

1. Stand 10

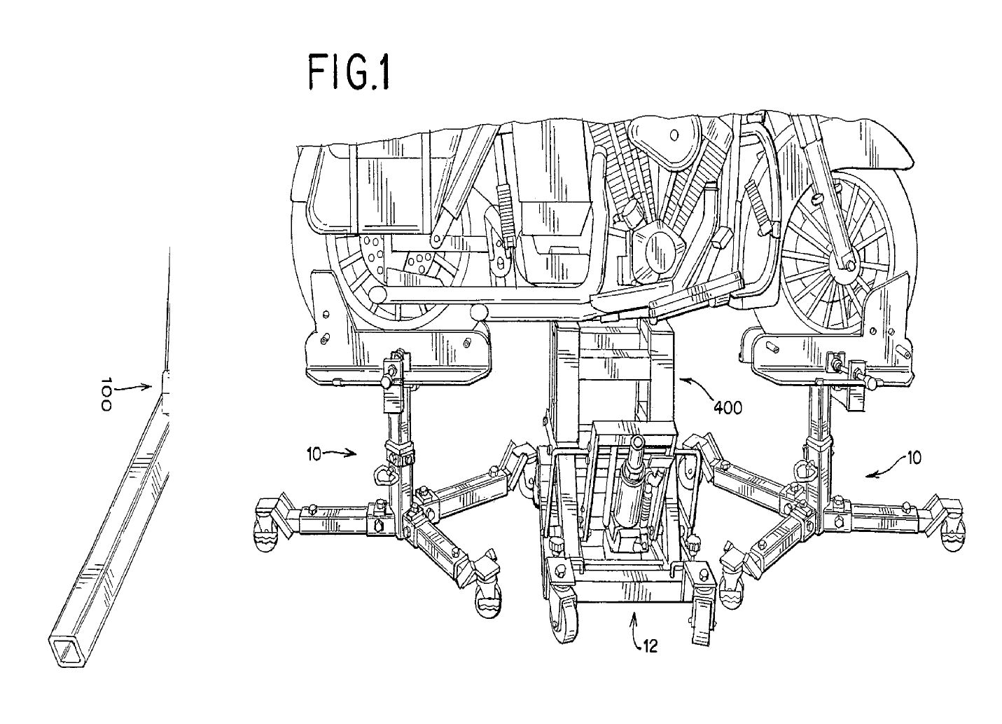

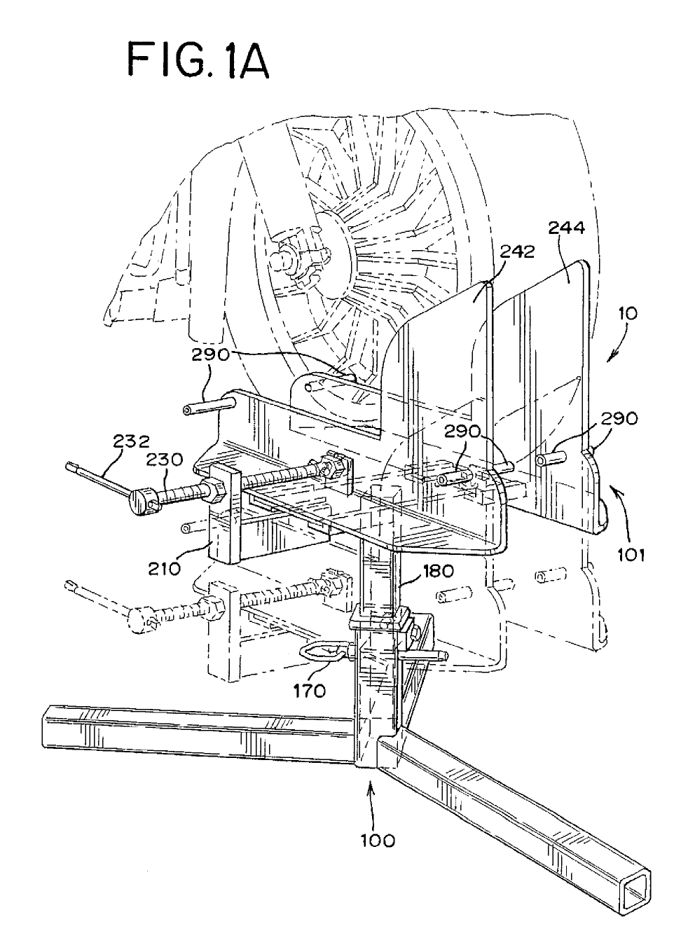

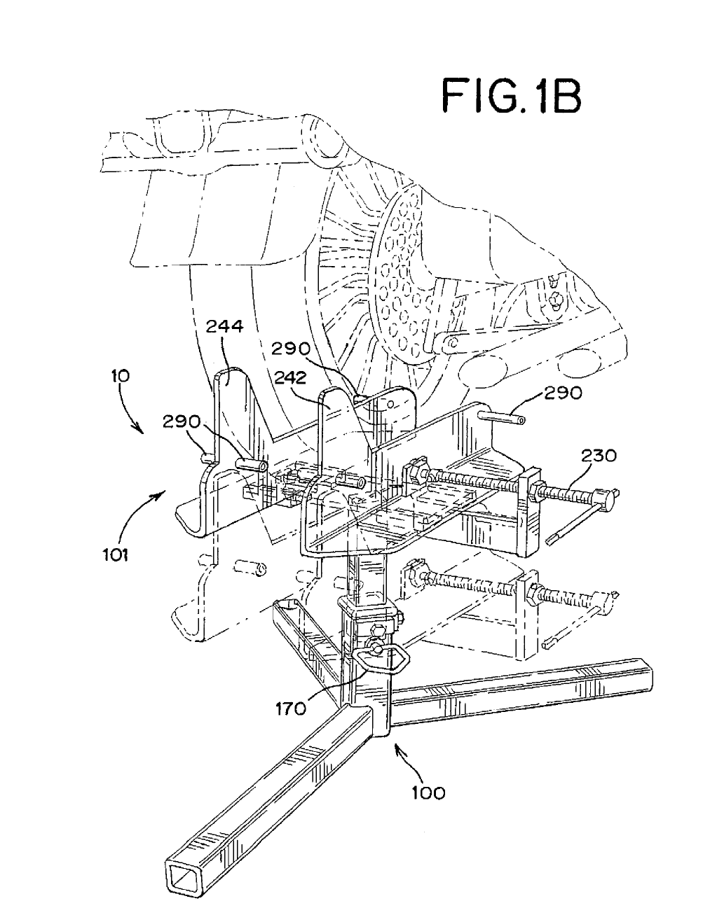

As shown in FIG. 1, an exemplary stand 10 may include more than one stand. For example, stand 10 may include a front stand 14 for holding the front wheel of a two-wheeled device, such as device 8, and/or a separate rear stand 16 for holding the rear wheel of a two-wheeled device, such as device 8. The separability of stands 14 and 16 may facilitate stacking and/or storing stands 14 and 16. Stand 10 may be designed to hold a device 8, such as a motorcycle, of any size up to at least about 16 inches off the ground in a stable and safe manner.

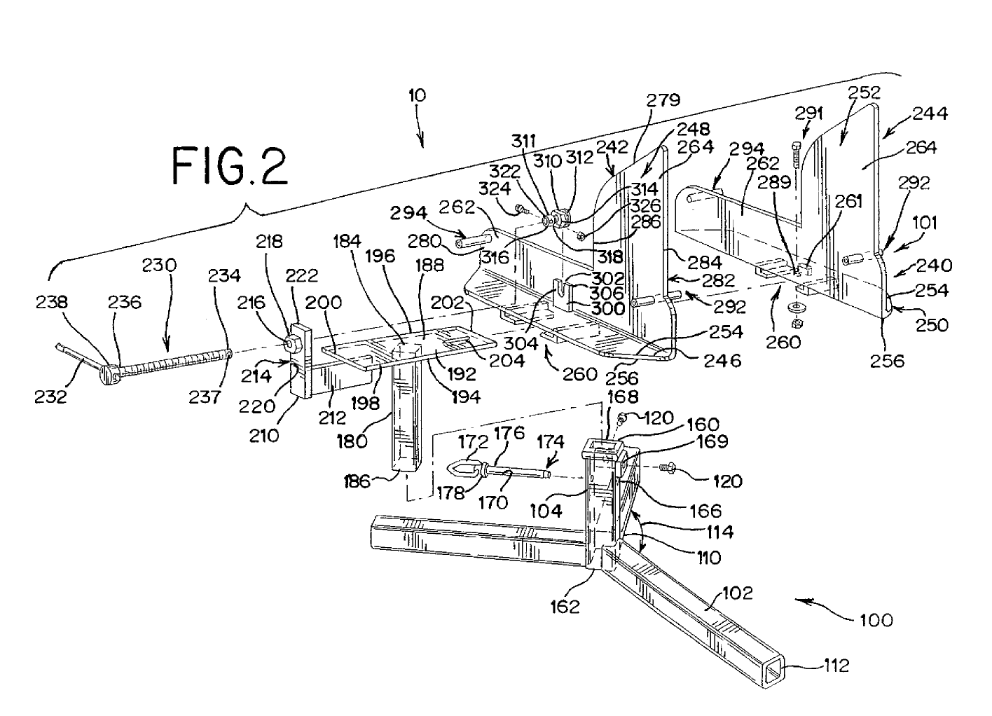

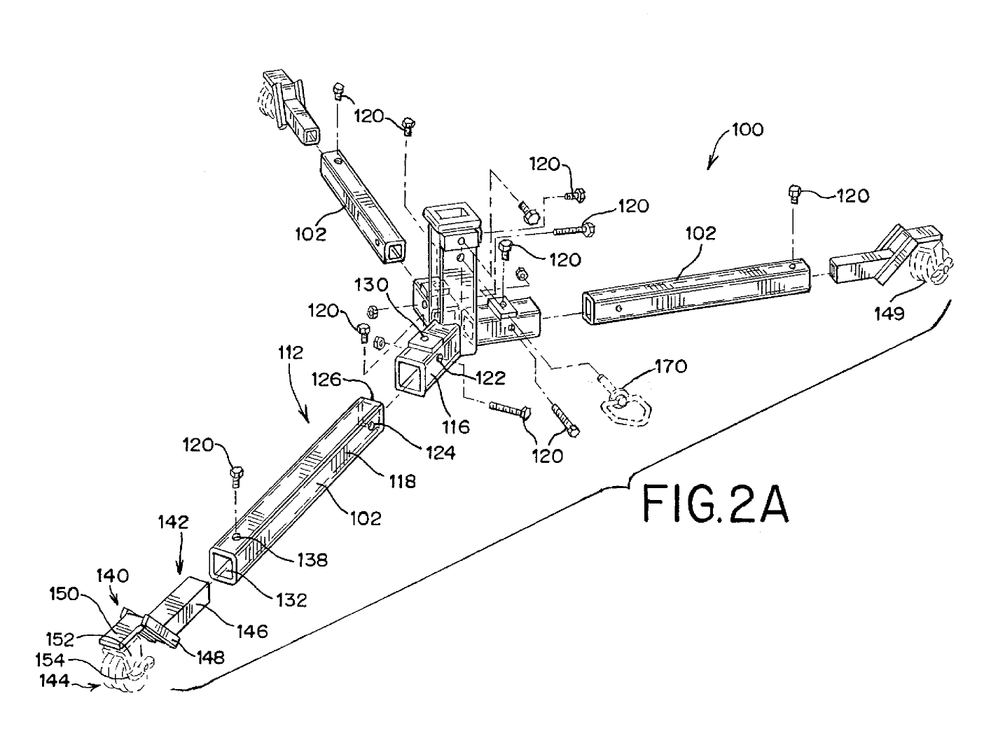

Turning to FIGS. 1A and 2, each stand 10 may include a base or tower 100 and a holder 101 that may be coupled together configured to hold a wheel or tire of device 8.

1.1 Base or Tower 100

Continuing with FIG. 2, each base or tower 100 may include a plurality of legs 102, a tower support 104 and a tower support pin. Base 100 may be configured to be positioned on the ground or a surface, such that legs 102 contact the ground or surface.

Each base 100 may be fabricated any suitable material, such as a metal material. For example, base 100 may be fabricated from steel, aluminum, titanium, and/or any combination thereof.

1.1A Tower Legs 102

Each base 100 may include a plurality of legs or tower legs 102. Each leg 102 may facilitate stabilizing stand 10 or base 100. In one embodiment, each leg has a substantially rectangular cross-section that may be substantially hollow, wherein the rectangular cross-section enables at least a portion of each leg to be substantially flush with the ground and having a hollow leg reduces the weight of each leg, saving costs, without compromising its function or structure. Alternatively, each leg may not be configured to be substantially flush with the ground, may have any cross-sectional shape and further may be solid.

In one embodiment, each leg 102 has a first end 110 and an opposing second end 112, wherein each first end 110 is coupled to a tower support 104 and extends outward therefrom. Further, in one embodiment, each leg 102 may be welded to tower support 104, preventing separation of the legs from tower support 104.

Further, in one embodiment, each leg 102 has a length between first end 110 and second end 112. The length may be between about 6 inches and about 5 feet, preferably between about 1 foot and about 3 feet, and in one embodiment, about 2 feet.

Moreover, in one embodiment, an angle 114 is defined between leg 102 and another adjacent leg 102. For example, as shown in FIG. 2, base 100 includes three legs 102, similar to a tripod, such that each angle 114 is an obtuse angle. Alternatively, angle 114 may be any angle, such as an acute angle or about a 90 degree angle.

In an alternative embodiment, as shown in FIG. 2A, each leg 102 is coupled to tower support 104 such that at least a portion of each leg 102 is removable from tower support 104. Having removable legs 102 or removable leg portions may facilitate portability and storability of stand 10 and/or base 10. Legs 102, as shown in FIG. 2A, may have a first portion 116 and a second portion 118. In such an embodiment, first portion 116 of each leg 102 may be welded to tower support 104, but second portion 118 of each leg 102 may be coupled to first portion 116 with one or more fastening mechanisms 120. For example, fastening mechanisms 120 may include screws, pins, nuts, threaded fasteners, washers, and/or bolts, such as jam bolts or locking jam bolts. Fastening mechanisms 120 may facilitate locking legs 102 in an engaged and locked position.

First and second portions 116 and 118 may have a similar cross-sectional shape to facilitate coupling them together. For example, first and second portions 116 and 118 may be removably coupled to one another. In one embodiment, first portion 116 may have a slightly larger perimeter than that of second portion 116 to allow second portion 116 to fit within first portion 116, such that first portion 116 and second portion 118 may telescope with one another. Further, in one embodiment, first portion 116 and second portion 118 are configured to be coaxial.

Additionally, each portion 116 may include at least one opening 122 and each portion 118 may include at least one opening 124, that may be proximate a first end 126 of portion 118. Openings 122 and 124 may be aligned with one another to receive one or more fastening mechanisms 120 therein. First portion 116 may include additional openings therein, such that one or more fastening mechanisms 120 may extend through more than one side of portion 116 and such that fastening mechanisms 120 may facilitate coupling portions 116 and 118 together. Further, first portion 116 may include another opening 130 configured to receive one or more fastening mechanisms 120 also to facilitate coupling portions 116 and 118 together.

Moreover, each portion 118 further may include at least one opening 128 that may be proximate a second end 132, wherein opening 128 may be configured to receive a fastening mechanism 120 to facilitate coupling one or more casters 140 to leg 102.

1.1B Casters 140

Continuing with FIG. 2A, in one embodiment, base 100 includes a plurality of caster wheels or casters 140 to facilitate the transportability and/or mobility of stand 10 and/or base 100. Each caster 140 may include a caster wheel support bracket 142 and a caster wheel 144. Bracket 142 may serve as a mount for casters 140. In one embodiment, caster wheel support bracket 142 is configured to couple to second end 132 of portion 118 of leg 102, wherein bracket 142 is inserted into a portion of end 132, and are tightened together and held via a fastening mechanism 120. Bracket 142 may include one or more portions. For example, bracket 142 may include a flush portion 146 configured to remain parallel to the ground or surface, that may be coaxial with portion 118 and that may telescope with portion 118. Additionally, bracket 142 may include an angled portion 148 that is coupled to and angled upward with respect portion 146. In one embodiment, angled portion 148 forms an angle 149 with respect to the ground, wherein angle 149 may be an acute angle. Bracket 142 also may include parallel portion 150 coupled to angled portion 148, such that parallel portion 150 may be substantially parallel to and spaced a distance above flush portion 146 and/or the ground. Portion 150 is spaced a distance from the ground to enable a caster wheel system 144 to be coupled thereto. Caster wheel system 144 may include a bracket 152 and a wheel 154. Bracket 152 may be rotatably coupled to bracket 142 to facilitate rotation of wheel 154. Alternatively, bracket 152 may be fixedly coupled to bracket 142 to prevent rotation of wheel 154.

1.1C Tower Support 104

Continuing with FIGS. 2 and 2A, each base 100 may include at least one tower support 104 coupled to at least one leg 102, with each tower support 104 having a first end 160 and a second end 162. In one embodiment, tower support 104 has a substantially rectangular cross-section that may be substantially hollow configured to receive an insert therein. Alternatively, tower support 104 may have any cross-sectional shape and further may have a solid portion.

In one embodiment, tower support 104 has a height defined substantially between ends 160 and 164, wherein the tower support height is less than the length of each leg 102. For example, tower support 104 may have a height that is about half the length of each leg 102. Height of tower support 104 may be between about 3 inches and about 2.5 feet, preferably between about 6 inches and about 1.5 feet, and in one embodiment, about 1 foot.

Additionally, in one embodiment, tower support 104 is substantially erect with respect to each leg 102 and each first end 110 of leg 102 may be coupled proximate second end 162 of tower support 140. Tower support 104 also may have a reinforced edge or opening 168 proximate first end 160.

Additionally, in one embodiment, tower support 104 may have a plurality of openings 166 defined therein. For example, tower support 104 may have two rows of openings, wherein one row is defined within one wall of tower support 104 and another row is defined in an opposing wall of tower support 104, such that each opening within each row aligns with an opening in another wall so that a fastening mechanism, such as a tower support pin 170 (described herein), can be inserted into an opening in a first row in one wall and further can be inserted through another opening in another row in another wall. Moreover, each opening within each row may be spaced from one another to facilitate adjustability of an insert and adjustability of stand 10.

Moreover, tower support 104 may include additional openings 169 defined within the walls of the tower support 104 and configured to receive other fastening mechanisms that may facilitate coupling or tightening tower support insert within tower support 104. Further, in one embodiment, a washer, as shown in at least FIG. 2, may be coupled to tower support 104 proximate opening 169 to ensure tightness, prevent leakage, and/or relieve friction.

1.1D Tower Support Pin 170

Tower support pin 170 is a pin, preferably with a handle 172, configured to extend through the openings in at least two walls of tower support 104 and may be configured to facilitate adjusting the height of stand 10 and/or base 100 and may also be configured to hold insert 180 in an engaged position. Pin 170 may have a diameter that is between about 0.25 inches and about 2 inches, preferably between about 0.5 inch and 1.5 inches, and in one embodiment about 1 inch. A gauge pin 170 with a wider diameter is less likely to bend from the weight of device 8, when device 8 is installed in stand 10.

Pin 170 may have a first end 174 and an opposing end 176. In one embodiment, the length of pin 170 between ends 174 and 176 is greater than the width of tower support 104. The length of pin 170 may be between about 3 inches and 1 foot, preferably between about 4 inches and 8 inches, and in one embodiment, about 6 inches. First end 174 may be a tapered end to facilitate inserting it into the openings within tower support 104, and second end 176 may be coupled to a stop 178. Stop 178 may limit the distance pin 170 may be inserted into tower support 104. Handle 172 may be coupled proximate end 176 and/or stop 178. Handle 172 is configured to enable a user to easily grab the handle to insert and remove pin 170 from tower support 104.

Further, when pin 170 is installed in tower support 104, pin 170 is configured to engage a tower support insert 180 to prevent the tower support insert 180 from sliding down past pin 170.

A clip (not shown) may be configured to engage a portion of pin 170 proximate at least one wall of tower support 104 to facilitate locking pin 170 in place and to facilitate.

1.2 Holder 101

Continuing with FIG. 2, each holder 101 may be configured to be hold a portion of device 8 therein in a safe and stable manner. Specifically, holder 101 may be configured to hold a tire or wheel of device 8 therein.

Each holder 101 may be fabricated any suitable material, such as a metal material. For example, holder 101 may be fabricated from steel, aluminum, titanium, and/or any combination thereof.

1.2A Tower Support Insert 180

Stand 10 may further include a column or post or tower support insert or insert 180 configured to be inserted into tower support 104 and may be configured to slide upwards and downwards within support 104 between two or more positions. For example, insert 180 may slide between an unengaged position and an engaged position that may be higher than the unengaged position. In one embodiment, insert 180 has a cross-sectional shape that is substantially similar to the cross-sectional shape of tower support 104 to facilitate coupling insert 180 and support 104. For example, insert 180 may have a substantially rectangular cross-section that is substantially similar to a rectangular cross-section of tower support 104. In another embodiment, insert 180 may have any cross-sectional shape that facilitates operation and use of stand 10. Also, in one embodiment, insert 180 is substantially solid, as opposed to being hollow.

In one embodiment, insert 180 may have a slightly smaller perimeter than the perimeter of support 104 to allow insert 180 to be inserted into and fit substantially flush within tower support 104, such that insert 180 and tower support 104 may telescope with one another. Further, in one embodiment, when insert 180 is inserted into first end 160 of tower support 104, insert 180 and support 104 are configured to be coaxial.

Further, in one embodiment, insert 180 has a length between first end 184 and second end 186. The length may be between about 3 inches and about 3.5 feet, preferably between about 6 inches and about 3 feet, and in one embodiment, about 1.5 foot.

Additionally, insert 180 may include a plurality of openings 182 sized to receive a fastening mechanism therein. Each opening 182 within insert 180 may be spaced a distance from the next respective opening 182 to facilitate adjustability of the insert. In one embodiment, insert 180 may have two rows of openings, wherein one row is defined within one wall of insert 180 and another row is defined in an opposing wall of insert 180. Alternatively, insert 180 has no openings defined therein.

When insert 180 is inserted into tower support 104, openings 182 may align with openings 166 and/or 169 within tower support 104, such that fastening mechanisms 120 and/or pin 170 may be inserted therethrough. Fastening mechanisms 120 and/or pin 170 may facilitate locking and/or stabilizing insert 180 within tower 104 at varying positions. The height of insert 180 within tower support 104 may be adjusted by translating insert 180 within tower 104 and then inserting the fastening mechanisms 120 and/or pin 170 within different openings 182, 166 and/or 169 in order to maintain insert 180 at the adjusted height.

Moreover, insert 180 may include a colored section that may act as a guide or warning for the user. For example, colored section may be red or yellow in color and may be paint or tape. Specifically, when the user sees the colored section on insert 180 while adjusting insert 180 within tower support 104, the user will be warned to either stop adjusting insert 180 or that the end of insert 180 is proximate first end 160 of tower support 104.

1.2B Plate or Tire Support 190

Continuing with FIG. 2, stand 10 may include a tire support or plate or tire support plate 190 that may couple proximate end 184 of insert 180 and may be configured to engage or form a resting place for a tire or wheel of device 8. Plate 190 and insert 180 may be welded together. Alternatively, plate 190 and insert 180 may be coupled together in any suitable way.

Plate 190 may have a first surface 192, an opposing second surface 194, a first edge 196, an opposing second edge 198, a third edge 200 extending between edges 196 and 198 and a fourth edge 202 also extending between edges 196 and 198. Additionally, plate 190 may have a thickness defined between surfaces 192 and 194. Thickness of plate 190 may be between about 0.5 inch to about 3 inches, preferably between about 1 inch and about 2 inches, and in one embodiment, about 1.5 inches. Additionally, plate 190 may have a width defined between edges 196 and 198 and plate 190 may have a length defined between edges 200 and 202. Width of plate 190 may be between about 0.5 inch to about 10 inches, preferably between about 3 inches and about 8 inches, and in one embodiment, about 6 inches, and length of plate 190 may be between about 6 inches to about 3 feet, preferably between about 1 foot and 2 feet, and in one embodiment, about 1.5 feet. In one embodiment, length of plate 190 is about three times the width of plate 190.

In one embodiment, insert 180 is welded to plate 190, preferably to first surface 192 or second surface 194, wherein insert is substantially perpendicular to plate 190. For example, end 180 may be welded to the center of plate 190, such that end 180 may be coupled to plate 190 about half way between edges 192 and 194 and about half way between edges 196 and 198. In one embodiment, walls of insert 180 are not parallel to edges 196, 198, 200 or 202. For example, walls of insert 180 may be transverse to edges 196, 198, 200 or 202.

Additionally, plate 190 may include a slot or opening 204. Slot 204 may be substantially parallel to edges 196 and 198 and transverse or perpendicular to edges 200 and 202. Further, slot 204 may be about 2 inches to about 3 inches long; however, slot 204 may have any length. Slot 204 also may be positioned between insert 180 and edge 202 and may be about half way between edges 196 and 198.

1.2C Vise Screw Support 210

Holder 101 may further include a screw support or vise screw support 210 that is configured to receive a vise screw. Support 210 may be configured to hold screw 230 in position to move vise portions or portions 242 and 244 between an open position and a closed or engaged position. Support 210 may include a first portion 212 and a second portion 214, preferably coupled together. Each portion 212 and 214 may be a substantially rectangular plate. Portion 212 is configured to couple to plate 188, wherein portion 212 may be welded to plate 188. In one embodiment, portion 212 is coupled to surface 194 of plate 188 between support 180 and edge 200.

Further, portion 214 may be coupled to portion 212, such that portion 214 is positioned a horizontal distance from plate 188. In one embodiment, portions 212 and 214 are welded together and are substantially perpendicular to one another. Alternatively, portion 214 may be coupled directly to plate 188, i.e., coupled to plate 188 without portion 212.

Also, as shown in FIG. 2, portion 214 has an opening 216 and a nut or washer 218 coupled thereto proximate opening 216. Opening 216 and nut 216 are configured to receive a vise screw therethrough. In one embodiment, opening 216 and nut 218 are positioned on an outer surface 220 of portion 214 proximate top edge 222 of portion 214 to facilitate holding and maintaining the vise screw a vertical distance above plate 188. The vertical distance may vary; however, the vertical distance may be between about 1 inch and about 3 inches, between about 1.2 inches and 2 inches, and in one embodiment, about 1.5 inches.

1.2D Vise Screw and Handle 230

Holder 101 further may include a vise screw or screw 230 and a handle 232. Screw 230 may be inserted into portion 214 and may apply pressure to both sides of at least one wheel and/or tire of device 8 to hold device 8 firmly in place. Screw 230 may facilitate horizontal adjustment of holder 101, preferably between an open position and a closed or engaged position, such that device 8 is held in place. Screw 230 may be threaded along its length between a first end 234 and a second end 236. The length of screw 230 may be about 6 inches to about 3 feet, preferably between about 1 foot and about 2 feet, and in one embodiment, about 2.5 feet. Screw 230 may have a diameter between about a 0.5 inch and about 2 inches, preferably between about 0.75 inch, and about 1.25 inches, and in one embodiment, about 1 inch.

In one embodiment, first end 234 may have an opening 237. Additionally, first end 234 may have a smooth section to facilitate inserting it through opening 216 in portion 214 of screw support 210, and second end 236 may be coupled to a stop 238. Stop 238 may limit the distance screw 230 may be inserted into support 210.

Handle 232 may be coupled proximate end 236 and/or stop 238. Handle 232 is configured to enable a user to turn screw 230 easily or with little effort. In one embodiment, handle 232 is substantially perpendicular to screw 230.

1.2E Vise 240

Holder 101 may further include a vise or brace 240 for engaging and/or holding device 8 in compression. Vise 240 may be configured to hold tires and/or wheels of device 8 by applying pressure to the tires to hold the wheels firmly in place. Vise 240 may include first portion 242 and a second portion 244. Each portion 242, 244 may couple to plate 190. In one embodiment, second portion 242 is a mirror image of second portion 244. Additionally, portions 242 and 244 may have tapered edges and round corners to reduce the risk of a user hurting themselves on sharp edges or corners.

First portion 242 may include a substantially horizontal portion 246 or a plate 262 and a substantially vertical portion 248 or a fin 264, and second portion 244 may include a substantially horizontal portion 250 or a plate 262 and a substantially vertical portion 252 or a fin 264. Horizontal portions 246 and 250 may engage plate 188, and vertical portions 248 and 252 may engage device 8, such as wheel or tire of device 8.

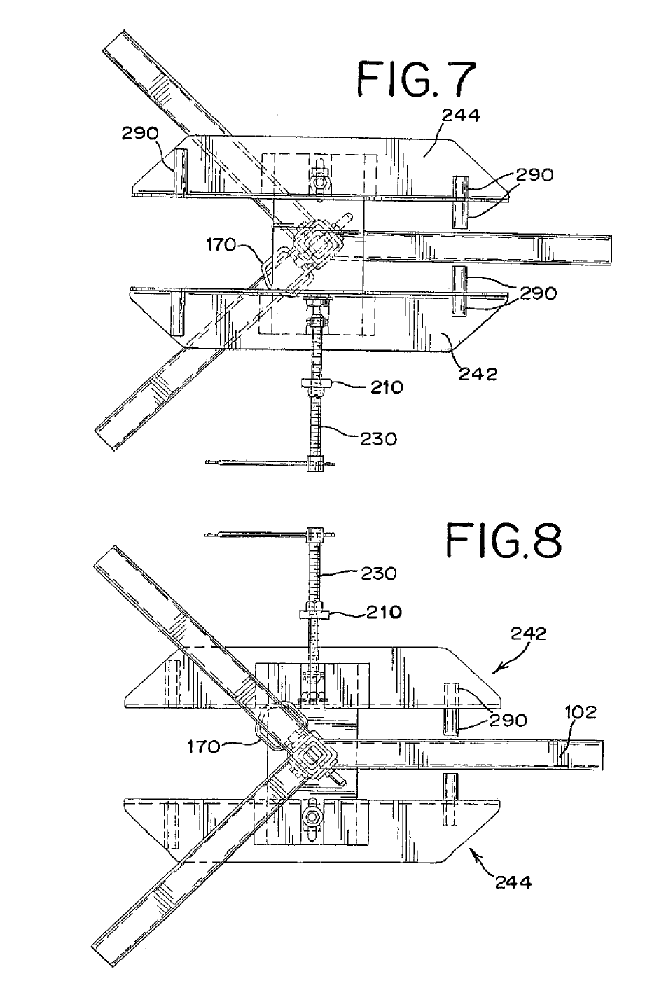

Turning to FIGS. 7 and 8, each plate 262 may have a width 266 that is between about 1 inch and about 1 foot, preferably between about 3 inches and about 8 inches, and in one embodiment, about 6 inches. Each plate 262 also may have a length 268 that is between about 1 foot and about 5 feet, preferably between about 2 feet and 4 feet, and in one embodiment, about 3 feet. In one embodiment, length 268 may be about six times as long as width 266.

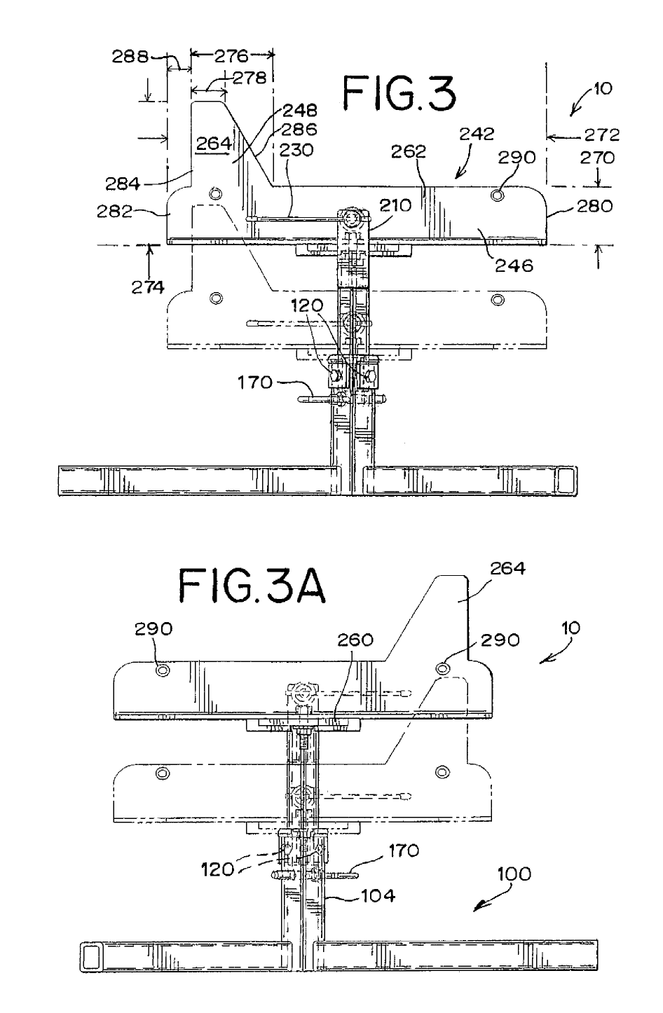

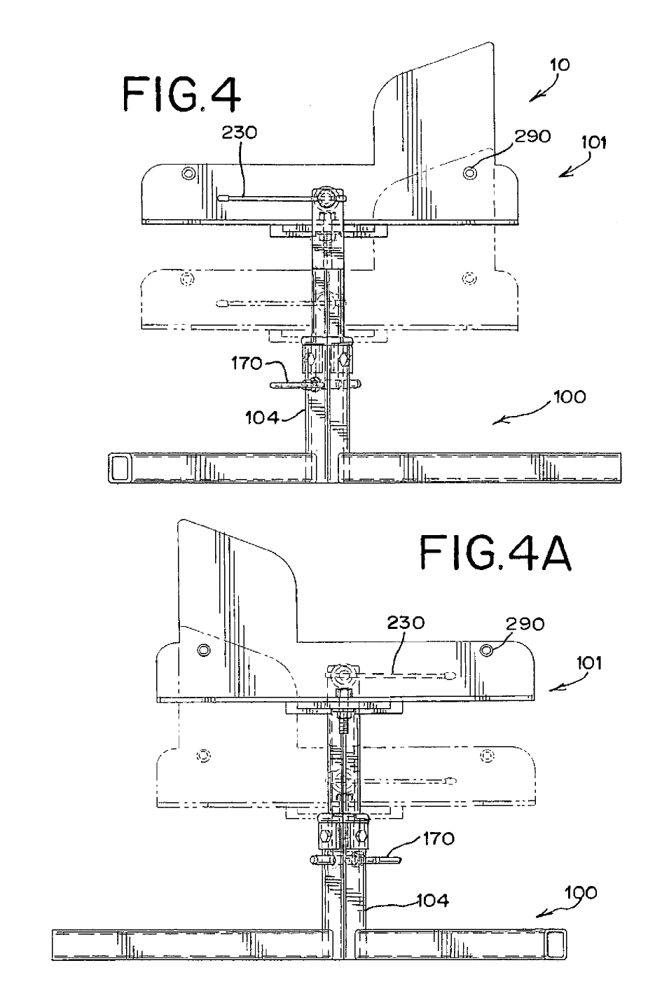

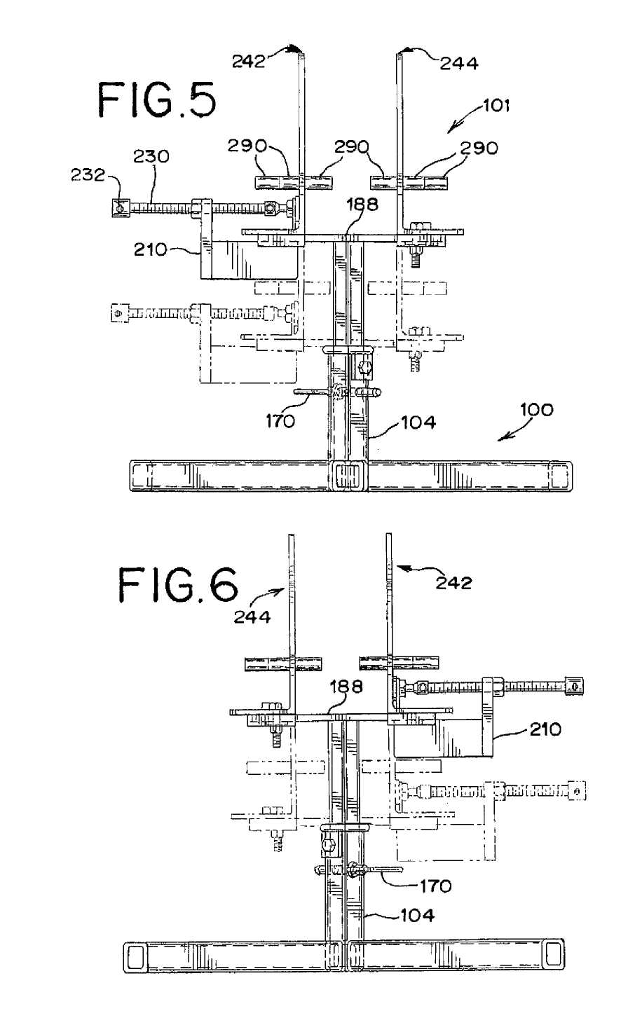

Turning to FIGS. 3, 3A, 4 and 4A, in one embodiment, each plate 262 may have an inward end or edge 280 and an opposing outward end or edge 282.

Continuing with FIGS. 3, 3A, 4 and 4A, each plate 262 may have a height 270 that is between about 1 inch and about 1 foot, preferably between about 3 inches and about 8 inches, and in one embodiment, about 6 inches. Each plate 262 also may have a length 272 that is between about 1 foot and about 5 feet, preferably between about 2 feet and 4 feet, and in one embodiment, about 3 feet. In one embodiment, length 272 may be about six times as long as height 270.

Fin 264 may increase stability of device 8 when device 8 is coupled within holder 101 of stand 10. Fin 264 may have a height 274 that is between about that is between about 1 inch and about 1 foot, preferably between about 3 inches and about 10 inches, and in one embodiment, about 8 inches.

Each fin 264 also may have a length 276 at its base and a length 278 at its top edge 279. In one embodiment, length 276 is greater than length 278, as fin 264 varies between its base and its top edge 279. In one embodiment, length 276 is between about 2 inches and about 1 foot, preferably between about 3 inches and 10 inches, and in one embodiment, about 6 inches. In an alternative embodiment, length 276 is less than length. In one embodiment, length 272 may be about 4.5 times the length of length 276. In another embodiment, lengths 276 and 278 are substantially the same, such that there is no tapering.

In one embodiment, top edge 279 of fin 264 tapers or is angled downward between fin side edges 284 and 286. Alternatively, top edge 279 is angled upward between side edges 284 and 286. In a further alternative embodiment, top edge 279 may not taper but may be substantially planar.

Moreover, fin 264 may be positioned a distance 288 from outward edge 282, such that fin 264 may be offset from edge 282. Edge 284 of fin 264 may be a distance from edge 282 that is between about 0.5 inch and about 3 inches, between about 0.75 inch and about 2 inches, and in one embodiment, about 1 inch.

Additionally, in one embodiment, length 278 is between about 1 inch and about 8 inches, preferably between about 3 inches and 6 inches, and in one embodiment, about 2 inches. In an alternative embodiment, length 276 is less than length. In one embodiment, length 272 may be about 4.5 times length 276.

Moreover, length 268 of each substantially horizontal portion 246 and 250 may be substantially the same as length 272 of each substantially vertical portions 248 and 252.

1.2F Shelf 260

In one embodiment, each substantially horizontal portion 246 and 250 has an upper surface 254 and a lower surface 256. Each lower surface 256 may include a shelf or ledge 260 configured to receive plate 188 therein. Shelf 260 may include a pair of ledges that extend downward from lower surface 256. In one embodiment, each ledge in the pair of ledges does not contact the other ledge in the pair.

Each ledge may have a substantially vertical portion that may extend downward a distance that may be substantially the same as the thickness of plate 188 and a substantially horizontal portion that may be substantially perpendicular to substantially vertical portion and may extend towards the other ledge. Each ledge within each pair of ledges is spaced a distance apart, wherein the distance may be about the width of plate 188 to facilitate sliding plate through the ledges. Shelf 260 further may include a stop 261 to facilitate stopping plate 188 from sliding. In one embodiment, stop 261 is coupled to horizontal portion 250 of second portion 244 and may be substantially perpendicular to the pair of ledges coupled to horizontal portion 250.

In one embodiment, horizontal portion may include at least one opening 289. Opening 289 is configured to receive a fastening mechanism 291, such that the fastening mechanism 291 may engage plate 188 and may facilitate locking portion 244 in a substantially fixed position. Fastening mechanism 291 may include screws, pins, nuts, bolts, threaded fasteners and/or washers. In one embodiment, fastening mechanism 291 is sized to be inserted in opening 204 of plate 188. Alternatively, fastening mechanism 291 may be any type of fastening mechanism to facilitate use and operation of holder 101. Alternatively, horizontal portion 246 may include at least one opening, similar to opening 289.

1.2G Rods 290

Holder 101 also may include a plurality of rods 290. Rods 290 may facilitate safety of holder 101 by holding the wheel or tire of device 8 in place to prevent the wheel from sliding or rolling forward or backwards. For example, rods 290 may hold device 8 in place on plate 188. In one embodiment, rods 290 are coupled to portions 242 and 244. For example, rods 290 may be welded to portions 242 and 244. Alternatively, rods 290 may be slid through openings (not shown) formed within portions 242 and 244 and then secured thereto.

Each rod 290 has a length that may be between about 1 inch and about 12 inches, preferably between about 2 inches and 10 inches and in one embodiment about 5 inches. Each rod 290 has a diameter that may be between about 0.25 inch and about 2 inches, preferably between about 0.5 inch and about 1.5 inches and in one embodiment, about 1 inch. Alternatively, each rod 290 may have a different length and may have a different diameter.

In one embodiment, holder 101 has two pairs of rods 290, an outward pair of rods 292 and an inward pair of rods 294. Outward pair of rods 292 may be proximate outward edge 282 and inward pair of rods 294 may be proximate inward edge 280. Further, each outward rod 292 and each inward rod 294 may be a distance above horizontal portions 246 and 250 that is between about one inch and about 6 inches, preferably between about 2 inches and about 4 inches, and in one embodiment, about 3 inches.

In one embodiment, one outward pair of rods 292 is coupled to portion 242 and one outward pair of rods 292 is coupled to portion 244, wherein the outward rods are configured to function together. In one embodiment, one inward pair of rods 294 is coupled to portion 242 and one inward pair of rods 294 is coupled to portion 244, wherein the inward rods are configured to function together. Alternatively, holder 101 may have one long rod that extends between both portions 242 and 244 and replaces the outward pair of rods 292, and holder 101 may have one long rod that extends between both portions 242 and 244 and replaces the inward pair of rods 294.

1.2H Pivot Pad Holder 300

Additionally, holder 101 may include a pivot pad holder 300. Pivot pad holder 300 may be configured to hold pad 310 and screw 230 in position. In one embodiment, pivot pad holder 300 is configured to receive a screw pivot pad. Pivot pad holder 300 may be coupled to horizontal portion 246 and/or vertical portion 248 of portion 242. In one embodiment, holder 300 is coupled to horizontal portion 246 and is slightly offset from vertical portion 248. Additionally, in one embodiment, holder 300 may be coupled in the center between edges 280 and 282. Alternatively, holder 300 may be coupled at any position between edges 280 and 282. In another embodiment, holder 300 may be coupled to portion 244.

In one embodiment, holder 300 having a first surface 304 and opposing second surface 306 may be substantially planar with an indentation 302 formed therein. Indentation 302 may be u-shaped.

1.21 Pivot Pad 310

Holder 101 further may include a pivot pad 310 having a first end 311 and a second end 313. Pad 310 may be configured to hold screw 230 in position and facilitate turning screw 230 easily. Pad 310 may include a guard 312, a nut 314, and/or a coupler 316.

Guard 312 may be proximate end 313 and may be substantially planar with a diameter that is configured to couple between vertical portion 246 and surface 306 of holder 300. Coupler 316 may include a coupling mechanism 318 and a connector 320. Coupling mechanism 318 may be proximate end 311 and may be configured to receive an end of screw 230 therein, such that diameter of coupling mechanism 318 may be similar or slightly smaller than the diameter of screw 230. Coupling mechanism 318 may have at least one opening 32 to receive a fastening mechanism 324. Fastening mechanism 324 may include screws, pins, nuts, bolts, threaded fasteners and/or washers. Fastening mechanism 324 may be inserted through at least one opening 322 such that it is substantially perpendicular to mechanism 318 and/or connector 320. Fastening mechanism 324 may facilitate tightening screw 230 within pad 310. Connector 320 may be configured to connect coupling mechanism 318 to nut 314 and guard 312.

2. Jack Extension 400

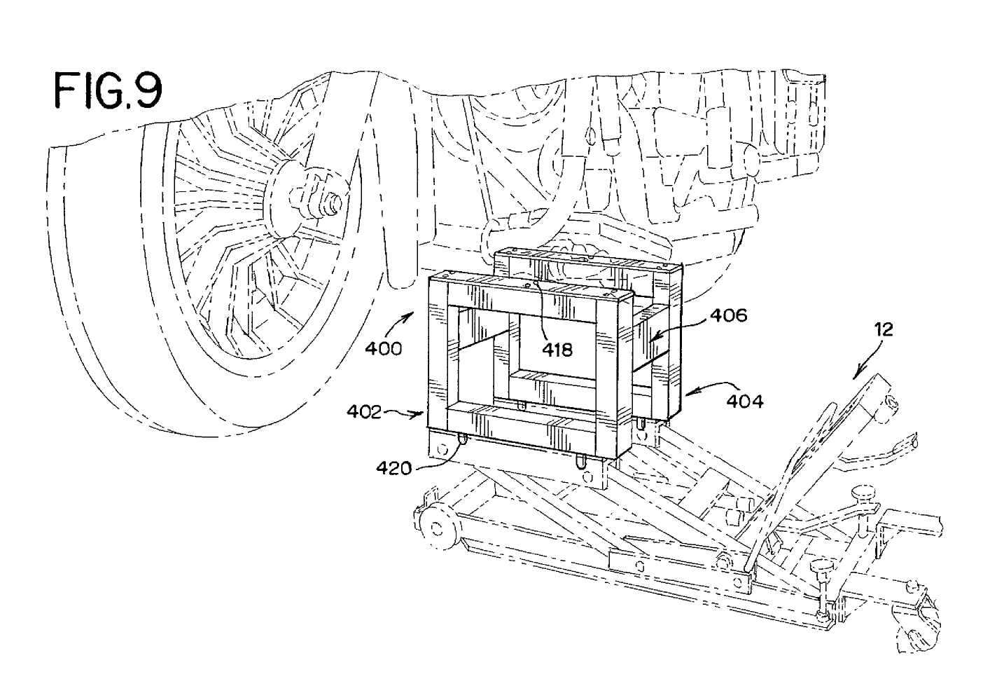

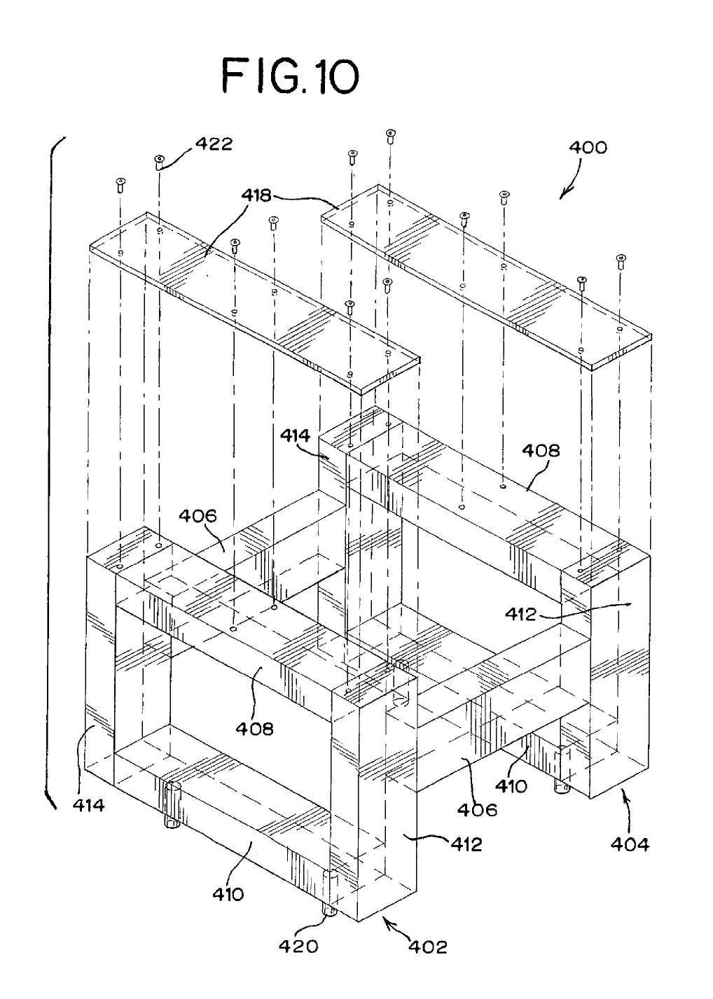

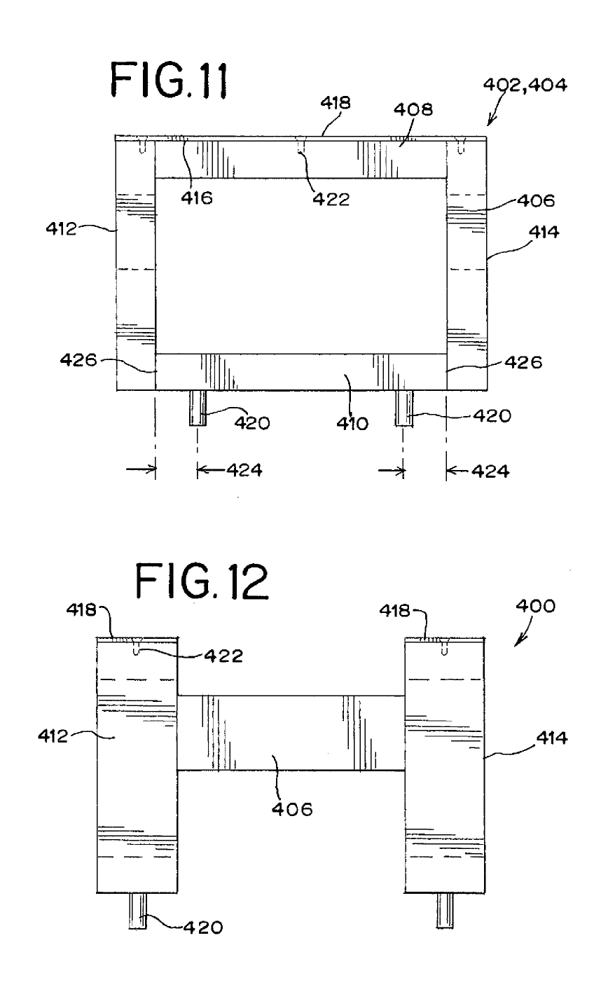

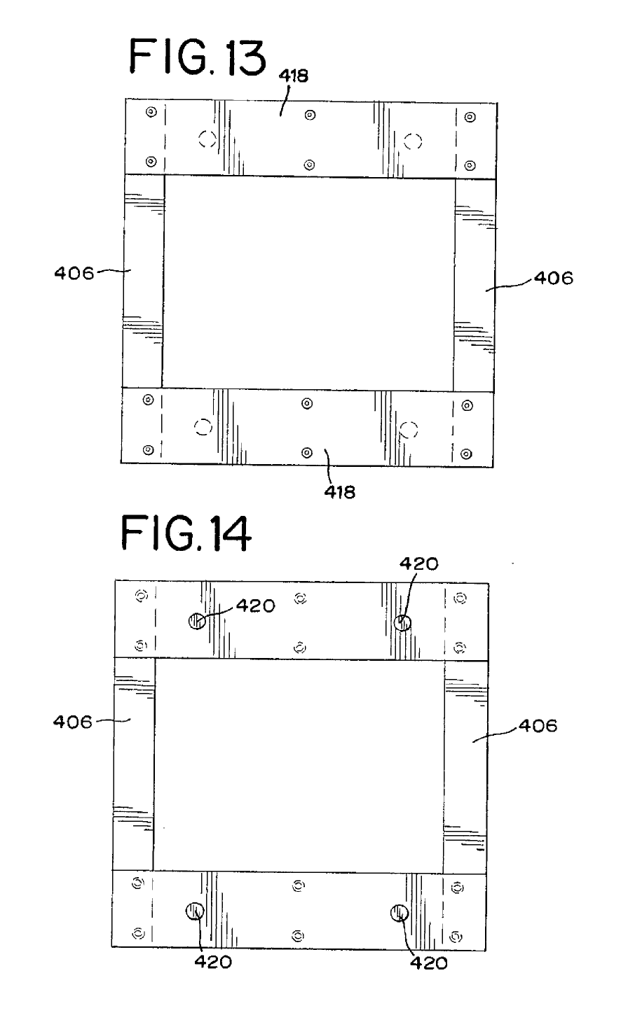

Turning to FIGS. 9-14, a jack extension 400 may be configured to be used with one or more stands 10. Jack extension 400 is configured to lift a device 8 to a height that is greater than that of a standard commercially available jack or lift 12. Extension 400 may be fabricated any suitable material, such as a metal material. For example, extension 400 may be fabricated from steel, aluminum, titanium, and/or any combination thereof.

Jack extension 400 may include a first end 402 and an opposing second end 404 with at least one cross-bar 406 therebetween. Turning to FIG. 11, in one embodiment, each end 402 and 404 has four sections that form a substantially rectangular end, and each of the four sections has a rectangular cross-section. Such a rectangular cross-section provides a substantially planar surface configured to couple to and provide stability to device 8. For example, each end 402 and 404 may include two horizontal sections, a first horizontal section 408 and a second horizontal section 410, and also may include two vertical sections, a first vertical section 412 and a second vertical section 414. In one embodiment, ends sections 408 and 410 are configured to be substantially flush with sections 412 and 414.

As shown in FIGS. 9 and 11, extension 400 includes a plurality of cross-bars 406, wherein each cross-bar 406 may be coupled between vertical sections 412 and 414. In one embodiment, extension 400 includes a pair of cross-bars 406 coupled between sections 412 and 414. In one embodiment, each cross-bar 406 is positioned substantially at or above a centerline of sections 412 and 414, and each cross-bar 406 may have a rectangular cross-section.

The length of sections 408 and 410 may be between about 6 inches and about 5 feet, preferably between about 1 foot and about 3 feet, and in one embodiment, about 2 feet. The length of sections 412 and 414 may be between about 6 inches and about 5 feet, preferably between about 2 feet and about 3 feet, and in one embodiment, about 1 foot. In one embodiment, the length of sections 408 and 410 are slightly longer than the length of sections 412 and 414.

In one embodiment, each section 408 and ends of sections 412 and 414 create a top substantially planar surface 416. A strip 418 may be coupled to top surface 416 to prevent scratching or damage to device 8. For example, strip 418 may be fabricated from rubber, and strip 418 may be coupled to surface 416 with rivets, glue, staples, nails, Velcro and/or any other suitable mechanism 422.

Additionally, section 410 may include at least one peg or post 420 extending therefrom, such that post 420 is configured to be inserted into an opening in a commercially available jack or lift, removably coupling extension 400 to jack 12. In one embodiment, a pair of posts 420 may extend downward from section 410.

In one embodiment, each post 420 has a diameter that is between about 0.1 inch and about 1 inch, preferably between about 0.3 inch and about 0.7 inch, and in one embodiment about 0.5 inch. Alternatively, each post 420 may have any shape suitable to engage jack 12; for example, each post 420 may have a rectangular cross-section. Further, in one embodiment, each post 420 has a length that is between about 0.1 inch and about 2.5 inches, preferably between about 0.3 inch and about 2 inches, and in one embodiment about 1 inch.

Moreover, as shown in FIG. 11, in one embodiment, post 420 is positioned a distance 424 away from an end 426 of section 410. Distance 424 may be between about 0.5 inch and about 3 inches, preferably between 1 inch and about 2 inches, and in one embodiment about 1.5 inches.

4. Use

Stand 10 may support a two-wheeled device 8, such as a motorcycle, in a safe and stable manner. A commercially available jack or motorcycle jack 12 may be used to lift device 8, including the wheels and tires, off of the ground. The jack used preferably is one that lifts device 8 from the center of the device 8. A stand 10 may be moved underneath each tire of device 8. For example, a front stand 14 for holding the front wheel of device 8 may be moved underneath the front tire of device 8 and/or a separate rear stand 16 for holding the rear wheel of device 8 may be moved underneath the rear tire of device 8. It is preferably that stands 14 and 16 are in a lower, unengaged position when each stand is positioned underneath each tire of device 8. If each stand 14 and 16 has casters 140, then each stand 14 and 17 may be wheeled or rolled into position under the tires of device 8.

Once stands 14 and 16 are in position, then the jack 12 is lowered such that device 8 is lowered onto and into stands 14 and 16. Specifically, in one embodiment, front wheel of device 8 is coupled to plate 188 of stand 14 and is positioned between portions 242 and 244 of stand 14, and rear wheel of device 8 is coupled to plate 188 of stand 16 and is positioned between portions 242 and 244 of stand 16. Screw 230 of stand 14 is then tightened such that portions 242 and 244 of stand 14 engage front tire and/or wheel of device 8, and screw 230 of stand 16 is then tightened such that portions 242 and 244 of stand 16 engage rear tire and/or wheel of device 8. Specifically, in one embodiment, both plates 262 and fins 264 engage tire and/or wheel of device 8. This holds the front and rear tires and wheels of device 8 in place or in a locked position. Additionally, each front and rear tire and wheel preferably is centered within each respective stand.

After tightening of device 8 within stands 14 and 16, the jack 12 is lowered into its lowest possible position and removed from underneath device 8. Extension 400 may then be coupled to jack 12. Extension 400 and jack 12 are then moved back underneath device 8. Jack 12 is then raised, such that extension 400 engages device 8 and lifts device 8 into a higher position. In one embodiment, the higher position is when the bottom of the tires and/or wheels of device 8 are about 16 inches off the ground. As device 8 is lifted towards the higher position with the use of jack 12 and extension 400, tower insert 180 moves and/or slides upward within tower support 104. A user may use the guide, i.e., by watching for a marking or colored section on insert 180 to appear, to determine when to stop raising device 8.

Once device 8 is in a higher position or a desired position, then pin 170 and/or fastening mechanisms 120 are used to lock insert 180 within tower 104 such that each stand 14 and 16 remains in that position. This position allows a user to access the entire underside of the device 8 without obstruction.

It should be understood, of course, that the foregoing relates to exemplary embodiments of the invention and that modifications may be made without departing from the spirit and scope of the invention as set forth in the following claims.

What is claimed is:

1. A stand to engage at least one wheel or tire of a device, comprising
a base having a plurality of legs and a tower extending upward therefrom;
a holder having
a tire plate coupled to the tower, wherein the tire plate is configured to engage the device;
a pair of vise portions coupled to the tire plate to facilitate retaining the device in a stable position;
a vise support extending from the tire plate; and
a fastening mechanism coupled to the vise support that facilitates moving the holder between an open position and an engaged position.

2. A stand according to claim 1, wherein the holder further comprises an insert configured to be inserted into the tower and wherein the insert is substantially perpendicular to the legs.

3. A stand according to claim 2, wherein the insert may be translated within the tower to adjust the height of the stand.

4. A stand according to claim 1, wherein the fastening mechanism is a screw and the screw includes a handle to facilitate turning the screw.

5. A stand according to claim 1, wherein each vise portion has a horizontal portion and a vertical portion, wherein the horizontal portion is coupled to the tire plate, wherein the vertical portion is substantially perpendicular to the horizontal portion and further wherein the vertical portion is configured to engage the device.

6. A stand according to claim 1, wherein the plurality of legs may be removably coupled to the tower.

7. A stand according to claim 1, wherein each vise portion includes a ledge configured to receive the tire plate.

8. A stand according to claim 1, wherein the vise support has a horizontal and a vertical portion, wherein the vertical portion is configured to receive the fastening mechanism.

9. A stand according to claim 1, wherein at least one of the vise portions has a pivot pad configured to engage the fastening mechanism.

10. A stand according to claim 1, wherein each vise portion has at least one rod configured to engage the device.

11. A system comprising:
at least one stand to engage at least one wheel or tire of a device, the stand having
a base having a plurality of legs and a tower extending upward therefrom;
a holder having
a tire plate coupled to the tower, wherein the tire plate is configured to engage the device;
a pair of vise portions coupled to the tire plate to facilitate retaining the device in a stable position;
a vise support extending from the tire plate; and
a fastening mechanism coupled to the vise support that facilitates moving the holder between an open position and an engaged position; and
at least one jack extension to couple to a jack, the jack extension comprising a first end and an opposing second end with at least one cross-bar extending therebetween, wherein the jack extension is configured raise the height of the device between a first position and a second higher position.

12. A system in accordance with claim 11, further comprising two stands, a front stand and a rear stand, wherein each of the front stand and the rear stand are configured to engage a tire or wheel of the device.

13. A system in accordance with claim 11, wherein the first end and the second end of the jack extension are configured to engage the body of the device.

14. A method of using a stand comprising:
lifting a two-wheeled device off of the ground to a predetermined first height;
placing a first stand underneath a first wheel of the device such that a first vise plate engages the first wheel;
placing a second stand underneath a second wheel of the device such that a second vise plate engages the second wheel;
tightening a first pair of vise plates proximate the first wheel with a first vise fastening mechanism to stabilize the first wheel;
tightening a second pair of vise plates proximate the second wheel with a second fastening mechanism to stabilize the second wheel;
raising the two-wheeled device to a predetermined second height, wherein the second predetermined height is greater than the first predetermined height.

15. A method according to claim 14, wherein raising the two-wheeled device to the predetermined second height further comprises translating a first insert within a first tower of the first stand and translating a second insert within a second tower of the second stand.

16. A method according to claim 15, wherein tightening each pair of vise portions further comprises moving one vise portion of the pair of vise portions, such that only one of the pair of vise portions is in motion.
